(19) United States
(12) Patent Application Publication
(10) Pub. No.: US 2025/0167457 A1
(43) Pub. Date: May 22, 2025

(54) WIRELESS COMMUNICATION DEVICE, OPERATING METHOD, AND SYSTEM

(71) Applicant: SAMSUNG ELECTRONICS CO., LTD., SUWON-SI (KR)

(72) Inventors: Wan Choi, Seoul-si (KR); Hojun Rho, Seoul-si (KR); Jiyoung Yun, Seoul-si (KR)

(73) Assignee: Seoul National University R&DB Foundation, Seoul (KR)

(21) Appl. No.: 18/926,702

(22) Filed: Oct. 25, 2024

(30) Foreign Application Priority Data
Nov. 22, 2023 (KR) 10-2023-0163787
Apr. 15, 2024 (KR) 10-2024-0050198

(51) Int. Cl. H01Q 21/06; H04B 1/40; H04B 7/04

(52) U.S. Cl. CPC H01Q 21/061; H04B 1/40; H04B 7/04

(57) ABSTRACT

Provided are a device for performing wireless communication to increase a data rate in a wireless communication system, an operating method of the device, and a wireless communication system including the device. A second device includes second antennas configured to transmit and receive radio frequency (RF) signals to and from a first device including first antennas in a wireless communication system, at least one RF chain configured to transmit and receive the RF signals to and from the second antennas, and a processing circuit configured to transmit and receive data signals to and from the at least one RF chain, wherein the processing circuit is further configured to adjust a spacing between the second antennas between the number of the first antennas, the number of the second antennas, and the number of the data signals.

### CROSS-REFERENCE TO RELATED APPLICATION

This application is based on and claims priority under 35 U.S.C. § 119 to Korean Patent Application Nos. 10-2023-0163787 and 10-2024-0050198, respectively filed on Nov. 22, 2023 and Apr. 15, 2024, in the Korean Intellectual Property Office, the disclosures of which are incorporated by reference herein in their entirety.

### TECHNICAL FIELD

This disclosure relates generally to wireless communication, and more particularly, to increasing a wireless communication data rate in a device, method and system.

### DISCUSSION OF RELATED ART

Recently, 5^{th} generation (5G) (“new radio” (NR)) communication system, which is a radio access technology, has aimed to provide data services at an ultra-high speed of several Gbps through use of “ultra-wideband” with a bandwidth of 100 MHz or more. 5G speeds may be higher than higher than legacy long term evolution (LTE) and long term evolution-advanced (LTE-A) systems. However, because it is difficult to secure an ultra-wideband frequency of 100 MHz or more in a frequency band of hundreds of MHz or several GHz used for LTE and LTE-A, the 5G communication system considers a method of transmitting a signal by using a wide frequency band existing in a frequency band of 6 GHz or more. For instance, in the 5G communication system, a transmission rate may be increased by using a millimeter wave band such as a 28 GHz band or a 60 GHz band.

Beamforming is a method in which a smart antenna with multiple antennas (“antenna elements” of an antenna array) focuses an antenna beam on a location of a specific terminal (e.g., a receiving device). The use of multiple antennas in both a transmitter and a receiver may be referred to as multiple-input and multiple-output (MIMO). MIMO may also involve the communication of several independent data streams, each propagating using the same frequency or frequency band from the transmitting device to the receiving device in a different path (different spatial streams).

However, due to multiple antennas, reception complexity may increase and a data rate and a beamforming gain may deteriorate in a line of sight (LoS) environment (which may not leverage many propagation paths). Accordingly, a need exists for a way to increase a data rate and a beamforming gain without such an increase in complexity.

### SUMMARY

Embodiments of the inventive concept provide a device for performing wireless communication which may increase a data rate and a beamforming gain by adjusting a spacing between antennas based on the number of data signals and generating a beamforming matrix based on a singular matrix for a matrix of a wireless channel through use of the adjusted spacing, an operating method of the device, and a wireless communication system including the device.

According to an aspect of the inventive concept, a second device includes second antennas configured to transmit and receive radio frequency (RF) signals to and from a first device including first antennas in a wireless communication system, at least one RF chain configured to transmit and receive the RF signals to and from the second antennas, and a processing circuit configured to transmit and receive data signals to and from the at least one RF chain, wherein the processing circuit is further configured to adjust a spacing between the second antennas based on a number of the first antennas, a number of the second antennas, and a number of the data signals.

According to another aspect of the inventive concept, an operating method of a second device including second antennas and at least one radio frequency (RF) chain and configured to perform wireless communication with a first device including first antennas includes reporting information about a number of the at least one RF chain to the first device, receiving antenna adjustment information generated based on the information about the number of the at least one RF chain, and adjusting a spacing between the second antennas based on the antenna adjustment information, wherein the antenna adjustment information includes a number of the first antennas, a number of the second antennas, a distance between the first device and the second device, and a number of data signals received by the second device.

According to another aspect of the inventive concept, a wireless communication system includes a first device including first antennas, at least one first radio frequency (RF) chain configured to transmit and receive RF signals to and from the first antennas, and a first processing circuit configured to transmit and receive data signals to and from the at least one first RF chain, and a second device including second antennas configured to transmit and receive the RF signals to and from the first antennas, at least one second RF chain configured to transmit and receive the RF signals to and from the second antennas, and a second processing circuit configured to transmit and receive the data signals to and from the at least one second RF chain, wherein the first processing circuit is further configured to adjust a spacing between the first antennas based on a number of the first antennas, a number of the second antennas, a distance between the first device and the second device, a wavelength of a carrier frequency, and a number of the data signals, and the second processing circuit is further configured to adjust a spacing between the second antennas based on the number of the first antennas, the number of the second antennas, the distance between the first device and the second device, the wavelength of the carrier frequency, and the number of the data signals.

### BRIEF DESCRIPTION OF THE DRAWINGS

Brief descriptions of respective drawings are provided to gain a sufficient understanding of the drawings referred to in the description of the inventive concept.

Embodiments will be more clearly understood from the following detailed description taken in conjunction with the accompanying drawings in which:

FIG. 1 is a diagram illustrating a wireless communication system, according to an embodiment;

FIG. 2 is a diagram illustrating an arrangement of antennas, according to an embodiment;

FIG. 3 is a flowchart illustrating a spacing between antennas of a device for performing wireless communication, according to an embodiment;

FIG. 4 is a diagram illustrating an arrangement of antennas, according to an embodiment;

FIG. 5 is a block diagram illustrating a base station of a wireless communication system, according to an embodiment;

FIG. 6 is a block diagram illustrating a user equipment of a wireless communication system, according to an embodiment;

FIG. 7 is a diagram for describing a beam forming matrix generation method of a wireless communication system, according to an embodiment;

FIG. 8 is a block diagram illustrating a beamforming matrix generation method of a wireless communication system, according to an embodiment;

FIGS. 9A and 9B are graphs illustrating the effect of a method of adjusting a spacing between antennas of a device for performing wireless communication, according to an embodiment;

FIG. 10 is a graph illustrating the effect of a beamforming matrix generation method of a wireless communication system, according to an embodiment;

FIG. 11 is a block diagram illustrating an electronic device, according to an embodiment; and

FIG. 12 is a conceptual diagram illustrating an Internet of things (IoT) network system to which an embodiment is applied.

### DETAILED DESCRIPTION OF EMBODIMENTS

Hereinafter, embodiments will be described in detail with reference to the accompanying drawings.

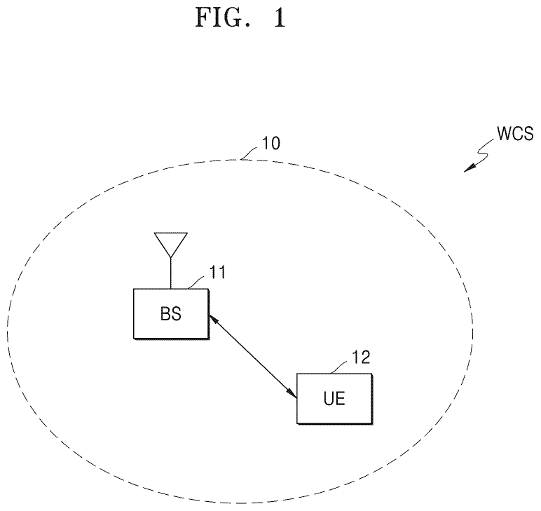

FIG. 1 is a block diagram illustrating a wireless communication system, according to an embodiment.

Hereinafter, embodiments are described based on a new radio (NR) network-based wireless communication system WCS, in particular, the 3GPP, but the technical idea of the inventive concept is not limited to the NR network. The technical idea of the inventive concept may be applied to other wireless communication systems having a similar technical background or channel configuration, for example, long term evolution (LTE), LTE-advanced (LTE-A), wireless broadband (WiBro), cellular communication systems, such as global system for mobile communication (GSM), or short-distance communication systems, such as Bluetooth and near-field communication (NFC).

Also, various functions described below may be implemented or supported by artificial intelligence technology or one or more computer programs, each of which includes computer-readable program code and is implemented in a computer-readable medium. The terms “application” and “program” refer to one or more computer programs, software components, sets of instructions, procedures, functions, objects, classes, instances, associated data, or portions thereof suitable for implementation of suitable computer-readable program code. The term “computer-readable program code” includes any type of computer code, including source code, object code, and executable code. The term “computer-readable medium” includes any type of medium capable of being accessed by a computer, such as a read-only memory (ROM), a random-access memory (RAM), a hard disk drive, a compact disc (CD), a digital video disc (DVD), or any other type of memory. “Non-transitory” computer-readable media exclude wired, wireless, optical, or other communication links that transmit transitory electrical or other signals. The non-transitory computer-readable media include media in which data may be permanently stored, and media in which data may be stored and later overwritten, such as a rewritable optical disk or a removable memory device.

In embodiments described below, a hardware approach is described as an example. However, because the embodiments include technology using both hardware and software, the embodiments do not exclude a software-based approach.

Referring to FIG. 1, a wireless communication system WCS may include a base station 11 and a user equipment (UE) 12. The base station 11 may generally refer to a fixed station that communicates with the UE 12 and/or other base stations (not shown), and may exchange data and control information by communicating with the UE 12 and/or other base stations (not shown). For example, the base station 11 may be referred to as a cell, a Node B, an evolved-Node B (eNB), a next generation Node B (gNB), a sector, a site, a base transceiver system (BTS), an access point (AP), a relay node, a remote radio head (RRH), a radio unit (RU), a small cell, a device, or the like. The base station 11 may provide wireless broadband access to the UE 12 within its coverage 10.

The UE 12 may be fixed or mobile, and may refer to any of devices capable of communicating with the base station 11 to transmit and receive data and/or control information. For example, the UE 12 may be referred to as a terminal, terminal equipment, a mobile station (MS), a mobile terminal (MT), a user terminal (UT), a subscriber station (SS), a wireless communication device, a wireless device, a handheld device, or the like. Although only the UE 12 is illustrated, the inventive concept is not limited thereto. For example, user devices (not shown) other than the UE 12 may be further included.

The base station 11 and the UE 12 may respectively include first antennas and second antennas, and the base station 11 or the UE 12 may perform beamforming by using the first antennas or the second antennas. For example, the beamforming may include at least one of analog beamforming that applies an analog beamforming matrix (or weight vector) to the first antennas or the second antennas, digital beamforming that applies a digital beamforming matrix (or weight vector) to RF chains respectively connected to the first antennas or the second antennas, or hybrid beamforming that applies an analog beamforming matrix (or first weight vector) to the first antennas or the second antennas and applies a digital beamforming matrix (or second weight vector) to at least one RF chain connected to the first antennas or the second antennas.

When there are multiple signal paths in a wireless channel between the base station 11 and the UE 12, because relatively little constructive or destructive interference occurs in a line of sight (LoS) environment, most of the multiple signal paths may be straight paths. When a straight path is formed, even though the number of antennas increases, a rank of a channel matrix may not increase, and even though data signals are transmitted according to the number of antennas, the data signals (which may also be referred to as a data stream) may not be transmitted in excess of the rank of the channel matrix. Accordingly, in an LOS environment, the spectral efficiency of digital beamforming where the number of antennas and the number of RF chains are the same may decrease, and the hardware cost for designing antennas may increase because the number of RF chains and the number of antennas are the same. The term “spectral efficiency” may refer to a data rate.

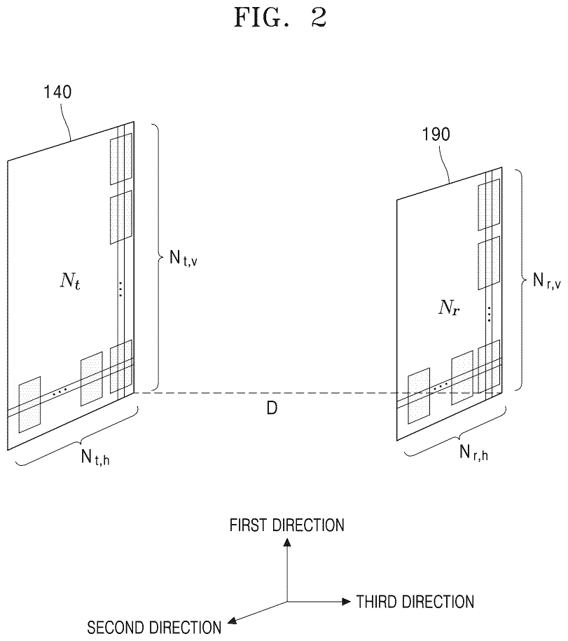

To solve these problems, the base station 11 or the UE 12 according to the inventive concept may adjust a spacing between the first antennas or the second antennas so that, when the number of data signals is less than the number of the first antennas or the second antennas, that is, hybrid beamforming is performed, a rank of a channel matrix is the same as the number of the data signals. Accordingly, a data rate of the base station 11 or the UE 12 may be increased. A specific embodiment in which the base station 11 or the UE 12 adjusts a spacing between the first antennas or the second antennas will be described below with reference to FIGS. 2 to 6. Herein, a spacing between antennas may be adjusted digitally, e.g., through interpolation of signals received by the physical antennas which have a fixed spacing therebetween.

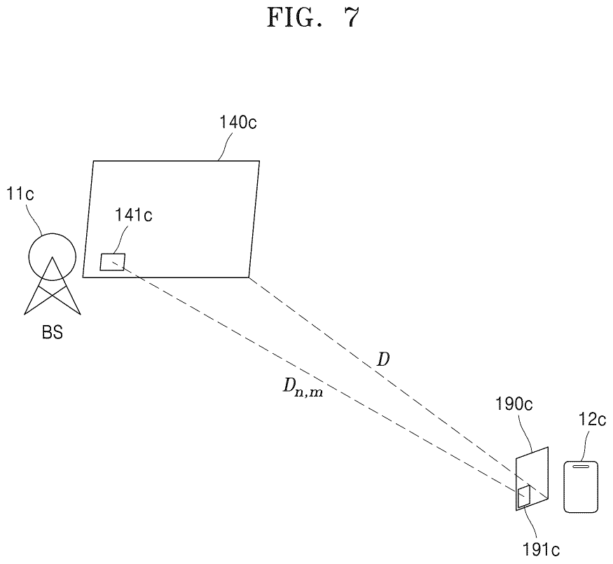

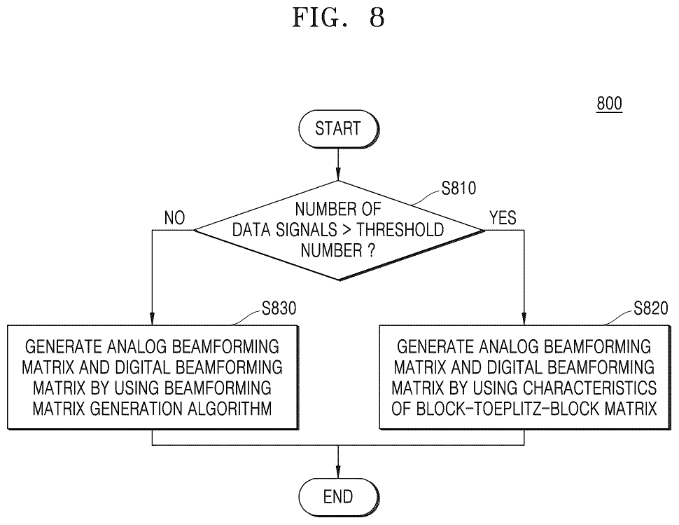

Also, the base station 11 or the UE 12 may generate a beamforming matrix that solves an optimization problem including an analog beamforming matrix based on a singular matrix of a channel matrix to perform hybrid beamforming by using the adjusted first antennas or second antennas. Accordingly, complexity may be reduced and a beamforming gain may be increased by using a relatively small number of RF chains by utilizing characteristics of an LoS environment. A specific embodiment in which the base station 11 or the UE 12 generates a beamforming matrix will be described below with reference to FIGS. 7 and 8.

FIG. 2 is a diagram illustrating an arrangement of antennas, according to an embodiment.

Referring to FIGS. 1 and 2, an arrangement of transmission antennas 140 and reception antennas 190 is illustrated. The transmission antennas 140 may be an example of first antennas included in the base station 11, and the reception antennas 190 may be an example of second antennas included in the UE 12. In some embodiments (and as illustrated in FIG. 2), an arrangement of the transmission antennas 140 and the reception antennas 190 may be a planar array, and the transmission antennas 140 may be parallel to the reception antennas 190. The term “planar array” may refer to a structure in which a plurality of antennas are arranged on the same plane and may refer to a plurality of linear antennas on the same plane. In other embodiments, one or both of the base station 11 and the UE 12 has only a single linear array.

For example, the transmission antennas 140 may include N_{t,v} antennas arranged in a first direction and N_{t,h} antennas arranged in a second direction and may include a total of Nₜ antennas. The reception antennas may include N_{r,v} antennas arranged in the first direction and N_{r,h} antennas in the second direction and may include a total of Nᵣ antennas. The first direction and the second direction may be perpendicular to each other and may be parallel to the transmission antennas 140 and the reception antennas 190. The transmission antennas 140 may be spaced apart from the reception antennas 190 by a distance D in a third direction, and the third direction may be perpendicular to the first direction and the second direction.

For example, if the planar array formed by the transmission antennas 140 is an L shaped planar array as illustrated in FIG. 2, and includes only a single linear array oriented in the first direction (e.g., vertical direction) and a single linear array oriented in the second direction (e.g., horizontal direction), then Nₜ may equal (N_{t,y}+N_{t,h}−1), since the set of N_{t,h} antennas and the set of N_{t,v} antennas share the corner antenna. In another example, although not illustrated in FIG. 2, the planar array includes a rectangular arrangement of antennas or a rectangular array (if all of the antennas are used together to form a beam), such that Nₜ equals N_{t,v}×N_{t,h} antennas. Analogous arithmetic may apply to the receiving antennas 190 to arrive at Nᵣ.

In some embodiments, the radiating portions of the transmission antennas 140 arranged in the first direction are each oriented in the first direction (e.g., in the case of a dipole, the dipole arms are oriented in the first direction); and the radiating portions of the transmission antennas arranged in the second direction are each oriented in the second direction. In this manner, the transmission antennas 140 arranged in the first direction may transmit signals that propagate with an orthogonal polarization relative to the signals transmitted by the transmission antennas 140 arranged in the second direction. Likewise, the same relative orientation may be applied to the receiving antennas arranged in the first direction compared to those arranged in the second direction. In other embodiments, the same polarization is generated for all signals.

In an LoS environment, a matrix structure of a wireless channel between the transmission antennas 140 and the reception antennas 190 may be similar to a two-dimensional (2D) discrete Fourier transform matrix, and a matrix of a wireless channel between the transmission antennas 140 and the reception antennas 190 may be expressed as in the following equation.

$$H = {H}_{v} ⊗ {H}_{h} \qquad [ Equation 1 ]$$

H may denote a matrix of a wireless channel between the transmission antennas 140 and the reception antennas 190, and Hᵥ may denote a matrix of a wireless channel between linear antennas in the first direction from among the transmission antennas 140 and linear antennas in the first direction from among the reception antennas 190. Hₕ may denote a matrix of a wireless channel between linear antennas arranged in the second direction from among the transmission antennas 140 and linear antennas arranged in the second direction from among the reception antennas 190. The matrices Hᵥ and Hₕ of the wireless channels may be the same as sub-matrices of discrete Fourier transform matrices, and referring to the property of a Kronecker product ⊗, a structure of the matrix H of the wireless channel may be the same as a sub-matrix of a 2D discrete Fourier transform matrix. By using first and second characteristics of a discrete Fourier transform matrix and third and fourth characteristics of a Kronecker product ⊗, ranks of the matrices Hᵥ and Hₕ of the wireless channels which are sub-matrices of one-dimensional (1D) discrete Fourier transform matrices may be obtained and a rank of the matrix H of the wireless channel which is a sub-matrix of a 2D discrete Fourier transform matrix may be obtained. The first characteristic may mean that non-zero eigenvalues of a sub-matrix of a discrete Fourier transform matrix have the same value, and the second characteristic may mean that a rank of a channel is determined by a dimension of the discrete Fourier transform matrix and a dimension of the sub-matrix. The third characteristic may mean that a rank (e.g., rank (A⊗B)) of a sub-matrix of a 2D discrete Fourier transform matrix is the same as a product (e.g., rank (A)·rank (B)) of ranks of sub-matrices of two discrete Fourier transform matrices constituting the matrix, and the fourth characteristic may mean that a singular value of the sub-matrix of the 2D discrete Fourier transform matrix is the same as a product of singular values of the sub-matrices of the two discrete Fourier transform matrices constituting the matrix.

In other words, the base station 11 of FIG. 1 may adjust a spacing between the transmission antennas 140 so that a rank of the matrix H of the wireless channel is the same as the number of data signals to increase a data rate by using the first to fourth characteristics, and the UE 12 of FIG. 1 may adjust a spacing between the reception antennas 190 so that a rank of the matrix H of the wireless channel is the same as the number of data signals to increase a data rate by using the first to fourth characteristics.

In some embodiments, a method of adjusting a spacing between the transmission antennas 140 and/or the reception antennas 190 by using the first to fourth characteristics may be expressed as in Equation 2 below, and Equation 2 may correspond to an embodiment in which the adjusted spacing between the transmission antennas 140 equals the adjusted spacing between the reception antennas 190.

$$\begin{matrix}2 ⌊ \frac{{d}_{t , v} {d}_{r , v} {N}_{t , v} {N}_{r , v}}{2 λ D} ⌋ = {N}_{s , v} \\ 2 ⌊ \frac{{d}_{t , h} {d}_{r , h} {N}_{t , h} {N}_{r , h}}{2 λ D} ⌋ = {N}_{s , h}\end{matrix} \qquad [ Equation 2 ]$$

In Eqn. 2, d_{{t,v}} and d_{{t,h}} may respectively denote a spacing between the transmission antennas 140 arranged in the first direction and a spacing between the transmission antennas 140 arranged in the second direction in an arrangement of the transmission antennas 140. d_{{r,v}} and d_{{r,h}} may respectively denote a spacing between the reception antennas 190 in the first direction and an interval between the reception antennas 190 in the second direction in an arrangement of the reception antennas 190. N_{{t,v}} and N_{{t,h}} may respectively denote the number of transmission antennas 140 arranged in the first direction along a single straight line (e.g., a vertical column as illustrated in FIG. 2) and the number of transmission antennas 140 arranged in the second direction along a single straight line (e.g., a horizontal row as illustrated in FIG. 2) in the arrangement of the transmission antennas 140. N_{{r,v}} and N_{{r,h}} may respectively denote the number of reception antennas 190 arranged in the first direction along a single straight line and the number of reception antennas 190 arranged in the second direction along a single straight line in the arrangement of the reception antennas 190. A total number Nₜ of the transmission antennas 140 may (in the case of a rectangular arrangement of transmission antennas 140) equal, N_{t,v}·N_{t,h}, and a total number Nᵣ of the reception antennas 190 may equal N_{r,v}·N_{r,h}. Herein, “first direction data signals” are data signals to be transmitted/received by antennas arranged in the first direction, and “second direction data signals” are data signals to be transmitted/received by antennas arranged in the second direction. N_{s,v} and N_{s,h} may respectively denote the number of first direction data signals and the number of second direction data signals, and the number Nₛ of data signals may equal N_{s,v}·N_{s,h}. A functional symbol └ ┘ may be a symbol of a floor function. λ may denote a wavelength of a carrier frequency, and D may denote a distance between the transmission antennas 140 and the reception antennas 190.

For example, the base station 11 of FIG. 1 or the UE 12 of FIG. 1 may adjust the spacing d_{{t,v}}, d_{{t,h}}, d_{{r,v}}, or d_{{r,h}} between antennas to satisfy Equation 2 based on the number Nₛ of data signals. Each of the data signals may be a signal of an independent data stream transmitted using the same or different carrier frequency as one or more other independent data stream.

In some embodiments, because the number Nₛ of data signals equals N_{s,v}·N_{s,h}, the base station 11 of FIG. 1 or the UE 12 of FIG. 1 may adjust N_{s,v} and N_{s,h} to suit an environment of the base station 11 of FIG. 1 and/or the UE 12 of FIG. 1 while satisfying that the number Nₛ of data signals equals N_{s,v}·N_{s,h}. The term “environment” may refer to an environment in which the base station 11 of FIG. 1 or the UE 12 of FIG. 1 is installed or located. For example, in an environment in which the available UE or base station device dimension in the first direction is wider than the dimension in the second direction, the base station 11 of FIG. 1 or the UE 12 of FIG. 1 may set N_{s,v} e to be greater than N_{s,h} while satisfying that Nₛ=N_{s,v}·N_{s,h}.

When the number Nₛ of data signals is less than the number Nₜ of the transmission antennas 140 or the number Nᵣ of the reception antennas 190, that is, when hybrid beamforming is performed, the base station 11 of FIG. 1 or the UE 12 of FIG. 1 may adjust the spacing d_{{t,v}}, d_{{t,h}}, d_{{r,v}}, or d_{{r,h}} between antennas so that a rank of a channel matrix is the same as the number Nₛ of data signals. Accordingly, a data rate of the base station 11 or the UE 12 may be increased.

In some embodiments, even when the number Nₛ of data signals equals the number Nₜ of the transmission antennas 140 or the number Nᵣ of the reception antennas 190, that is, when digital beamforming is performed, the base station 11 of FIG. 1 or the UE 12 of FIG. 1 may adjust the interval d_{{t,v}}, d_{{t,h}}, d_{{r,v}}, or d_{{r,h}} between antennas by using Equation 2.

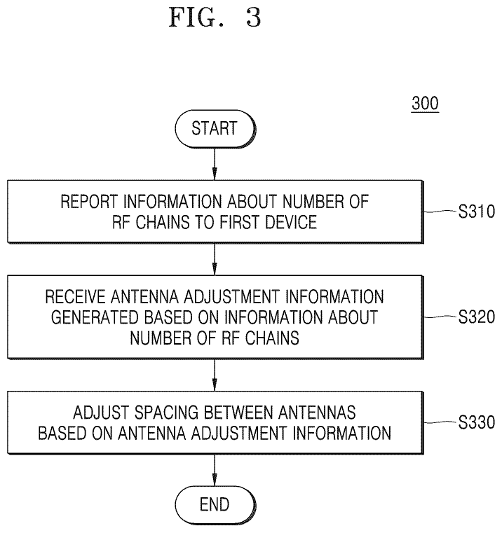

FIG. 3 is a flowchart illustrating a method of adjusting an interval between antennas of a device for performing wireless communication, according to an embodiment. Referring to FIG. 3, a method 300 of adjusting an interval between antennas of a second device for performing wireless communication with a first device may include operations S310 to S330. The first device may be an example of the base station 11 of FIG. 1, and the second device may be an example of the UE 12 of FIG. 1. Although the following will be described assuming that the first device is the base station 11 of FIG. 1 and the second device is the UE 12 of FIG. 1, the inventive concept is not limited thereto. For example, the first device may be an example of the UE 12 of FIG. 1, and the second device may be an example of the base station 11 of FIG. 1. Redundant description as that with reference to FIG. 1 may be omitted.

In operation S310, a second device may include at least one RF chain and second antennas and may report information about the number of RF chains to a first device. For example, when the second device performs hybrid beamforming, the second device may report information about the number of RF chains which is less than the number of second antennas to the first device, and when the second device performs digital beamforming, the second device may report information about the number of RF chains that equal the number of second antennas to the first device.

In operation S320, the second device may receive antenna adjustment information generated based on the information about the number of RF chains. In some embodiments, the first device including first antennas may generate the antenna adjustment information based on the information about the number of RF chains. The antenna adjustment information may include the number of first antennas, the number of second antennas, a distance between the first device and the second device, a wavelength of a carrier frequency, and the number of data signals received by the second device from the first device.

In operation S330, the second device may adjust a spacing between antennas based on the antenna adjustment information. In some embodiments, the second device may adjust a spacing between the second antennas by substituting the antenna adjustment information into Equation 2 described with reference to FIG. 2.

In some embodiments, the first device may also adjust a spacing between the first antennas. For example, the first device may adjust a spacing between antennas by substituting the antenna adjustment information generated in operation S320 into Equation 2 described with reference to FIG. 1.

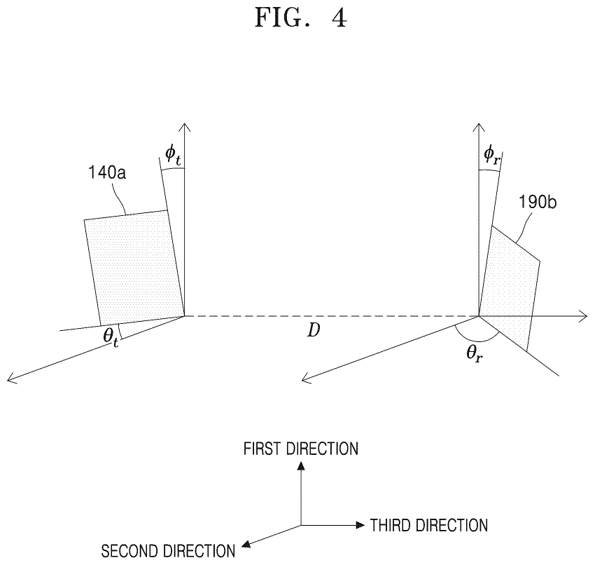

FIG. 4 is a block diagram illustrating an arrangement of antennas, according to an embodiment.

Referring to FIGS. 1 and 4, an arrangement of transmission antennas 140a and reception antennas 190a is illustrated. The transmission antennas 140a may be an example of first antennas included in the base station 11, and the reception antennas 190b may be an example of second antennas included in the UE 12. In some embodiments, an arrangement of the transmission antennas 140a and the reception antennas 190a may be a planar array, and the transmission antennas 140a may not be parallel to the reception antennas 190a. The term “planar array” may refer to a structure in which a plurality of antennas are arranged on the same plane and may refer to a plurality of linear antennas on the same plane.

For example, the transmission antennas 140a may include N_{t,v} antennas in the first direction and N_{t,h} antennas in the second direction, and may include a total of Nₜ antennas. The reception antennas 190a may include N_{r,v} antennas in the first direction and N_{r,h} antennas in the second direction and may include a total of Nᵣ antennas. The first direction, the second direction, and the third direction may be perpendicular to each other, and the transmission antennas 140a may be spaced apart from the reception antennas 190a by the distance D in the third direction. The transmission antennas 140a may be inclined by ϕₜ from an axis in the first direction and may be inclined by θₜ from an axis in the second direction. The reception antennas 190a may be inclined by ϕᵣ from an axis in the first direction and may be inclined by θᵣ from an axis in the second direction.

In some embodiments, the base station 11 of FIG. 1 or the UE 12 of FIG. 1 may calculate the interval d_{{t,v}}, d_{{t,h}}, d_{{r,v}}, or d_{{r,h}} between antennas to satisfy Equation 2 described with reference to FIG. 2 based on the number of data signals, and may adjust a spacing between the transmission antennas 140a or the reception antennas 190a by substituting the calculated interval d_{{t,v}}, d_{{t,h}}, d_{{r,v}}, or d_{{r,h}} between antennas into the following equation.

$$\begin{matrix}( \begin{matrix}{x}_{m} \\ {y}_{m} \\ {z}_{m}\end{matrix} ) = ( \frac{\begin{matrix}{d}_{t , v} {m}_{v} \\ {d}_{t , h} {m}_{h} \\ cos {θ}_{t} sin {ϕ}_{t} {d}_{t , v} {m}_{v} + sin {θ}_{t} {d}_{t , h} {m}_{h}\end{matrix}}{- cos {θ}_{t} cos {ϕ}_{t}} ) , \\ ( \begin{matrix}{x}_{n} \\ {y}_{n} \\ {z}_{n}\end{matrix} ) = ( D + \frac{\begin{matrix}{d}_{r , v} {n}_{v} \\ {d}_{r , h} {n}_{h} \\ cos {θ}_{r} sin {ϕ}_{r} {d}_{r , v} {n}_{v} + sin {θ}_{r} {d}_{r , h} {n}_{h}\end{matrix}}{- cos {θ}_{r} cos {γ}_{r}} ) .\end{matrix} \qquad [ Equation 3 ]$$

xₘ, [symbol] ₘ, and zₘ in may respectively denote an adjusted axial coordinate in the first direction, an adjusted axial coordinate in the second direction, and an adjusted axial coordinate in the third direction of an m^{th} antenna from among the transmission antennas 140a. mᵥ and mⱼ may respectively denote an axial coordinate in the first direction and an axial coordinate in the second direction of the m^{th} antenna from among the transmission antennas 140a. xₙ, [symbol] ₙ, and zₙ may respectively denote an adjusted axial coordinate in the first direction, an adjusted axial coordinate in the second direction, and an adjusted axial coordinate in the third direction of an n^{th} antenna from among the reception antennas 190a. nᵥ and nₕ may respectively denote an axial coordinate in the first direction and an axial coordinate in the second direction of the n^{th} antenna from among the reception antennas 190a.

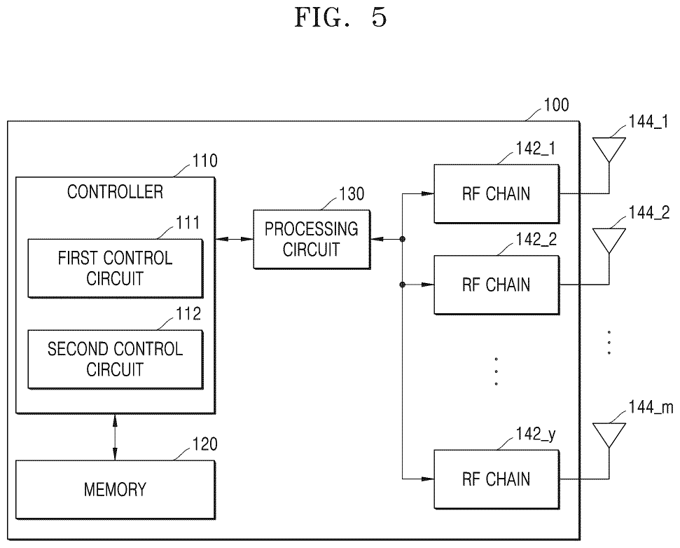

FIG. 5 is a block diagram illustrating a base station of a wireless communication system, according to an embodiment. An implementation example of a base station 100 of FIG. 5 may be applied to the base station 11 of FIG. 1.

The base station 100 may include a controller 110, a memory 120, a processing circuit 130, first RF chains 142_1 to 142_y, and first antennas 144_1 to 144_m. The first RF chains 142_1 to 142_y may receive RF signals transmitted by a UE (e.g., the UE 12 of FIG. 1) within coverage from the first antennas 144_1 to 144_m. The first RF chains 142_1 to 142_y may generate intermediate frequency (IF) or baseband signals by performing frequency down-conversion on the received RF signals.

In some embodiments, the number of the first RF chains 142_1 to 142_y may be less than the number of the first antennas 144_1 to 144_m, and the base station 100 may perform hybrid beamforming. In some embodiments, the number of the first RF chains 142_1 to 142_y may be the same as the number of the first antennas 144_1 to 144_m, and the base station 100 may perform digital beamforming.

The controller 110 may additionally process data signals. In some embodiments, a program and/or a process stored in the memory 120 may be executed to perform an overall control operation on the base station 100.

The processing circuit 130 may generate data signals by filtering, decoding, and/or digitizing the IF or baseband signals, and the processing circuit 130 may receive data signals from the controller 110. The processing circuit 130 may encode, multiplex, and/or change the received data signals into analog signals. The first RF chains 142_1 to 142_y may perform frequency up-conversion on the IF or baseband signals output from the processing circuit 130 and may transmit the same as RF signals to the UE (e.g., the UE 12 of FIG. 1) through the first antennas 144_1 to 144_m.

In some embodiments, the controller 110 may control an operation of the processing circuit 130. For example, a first control circuit 111 included in the controller 110 may generate antenna adjustment information described with reference to FIG. 3, and the processing circuit 130 may receive the antenna adjustment information, and may adjust a spacing between the first antennas 144_1 to 144_m by substituting the antenna adjustment information into Equation 2 described with reference to FIG. 2.

For example, a second control circuit 112 included in the controller 110 may generate a control signal for controlling an operation in which the processing circuit 130 generates a beamforming matrix, and the processing circuit 130 may perform an operation of generating a beamforming matrix based on the control signal. An operation of generating a beamforming matrix will be described below with reference to FIGS. 7 and 8.

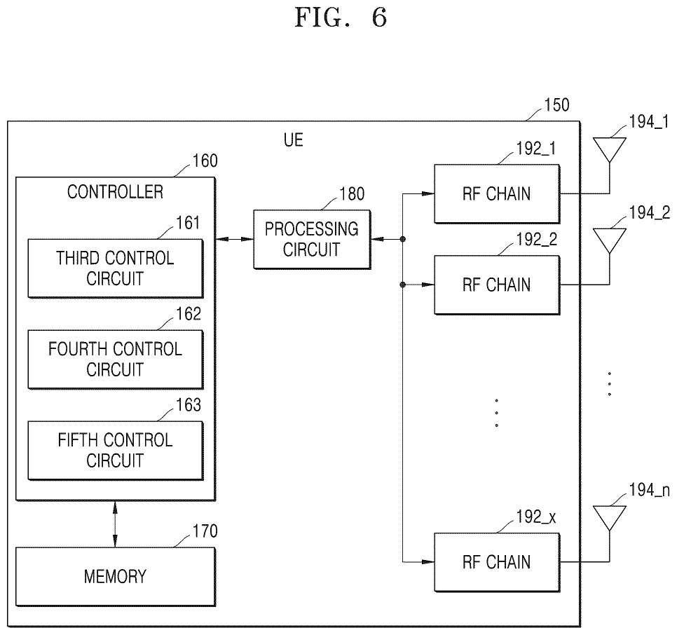

FIG. 6 is a block diagram illustrating a UE of a wireless communication system, according to an embodiment. An implementation type of a UE 150 of FIG. 6 may be applied to the UE 12 of FIG. 1.

The UE 150 may include a controller 160, a memory 170, a processing circuit 180, second RF chains 192_1 to 192_x, and second antennas 194_1 to 194_n. The second RF chains 192_1 to 192_x may receive RF signals transmitted by the base station 11 of FIG. 1 from the second antennas 194_1 to 194_n. The second RF chains 192_1 to 192_x may generate intermediate frequency (IF) or baseband signals by performing frequency down-conversion on the received RF signals.

In some embodiments, the number of the second RF chains 192_1 to 192_x may be less than the number of the second antennas 194_1 to 194_n, and the UE 150 may perform hybrid beamforming. In some embodiments, the number of the second RF chains 192_1 to 192_x may equal the number of the second antennas 194_1 to 194_n, and the UE 150 may perform digital beamforming.

The controller 160 may additionally process data signals. In some embodiments, a program and/or a process stored in the memory 170 may be performed to perform an overall control operation on the UE 150.

The processing circuit 180 may generate data signals by filtering, decoding, and/or digitizing the IF or baseband signals, and the processing circuit 180 may receive data signals from the controller 160. The processing circuit 180 may encode, multiplex, and/or change the received data signals into analog signals. The second RF chains 192_1 to 192_x may perform frequency up-conversion on the IF or baseband signals output from the processing circuit 130 and may transmit the same as RF signals to the base station 100 of FIG. 1 through the second antennas 194_1 to 194_n.

In some embodiments, the controller 160 may control an operation of the processing circuit 180. For example, a third control circuit 161 included in the controller 160 may generate information about the number of second RF chains described with reference to FIG. 3, and the processing circuit 130 may receive the information about the number of second RF chains, and may transmit the information about the number of second RF chains to the base station 100 of FIG. 1 through the second RF chains 192_1 to 192_x and the second antennas 194_1 to 194_n.

For example, a fourth control circuit 162 included in the controller 160 may generate a control signal for controlling an operation in which the processing circuit 180 adjusts a spacing between the second antennas 194_1 to 194_n, and the processing circuit 180 may adjust a spacing between the second antennas 194_1 to 194_n by substituting antenna adjustment information into Equation 2 described with reference to FIG. 2 based on the control signal.

For example, a fifth control circuit 163 included in the controller 160 may generate a control signal for controlling an operation in which the processing circuit 130 generates a beamforming matrix, and the processing circuit 130 may perform an operation of generating a beamforming matrix based on the control signal. An operation of generating a beamforming matrix will be described below with reference to FIGS. 7 and 8.

FIG. 7 is a block diagram for describing a beamforming matrix generation method of a wireless communication system, according to an embodiment.

Referring to FIGS. 1 and 7, a base station 11c and a UE 12c may be respectively an example of the base station 11 of FIG. 1 and an example of the UE 12 of FIG. 1. Redundant description as that made with reference to FIG. 1 may be omitted.

The base station 11c and the UE 12c may perform a hybrid beamforming operation, and should generate a beamforming matrix to perform the hybrid beamforming operation. A beam forming matrix for a digital beamforming operation may be generated based on a matrix of a wireless channel, but an optimization problem should be solved to generate the beamforming matrix for the hybrid beamforming operation based on the matrix of the wireless channel. The optimization problem may be solved by obtaining a beamforming matrix satisfying the following equation.

$$\begin{matrix}( {F}_{RF} , {F}_{BB} ) = {arg min}_{{F}_{RF} , {F}_{BB}} {‖ {F}_{opt} - {F}_{RF} {F}_{BB} ‖}_{F} \\ s . t . {F}_{RF} ∈ {ℱ}_{RF} , \\ {‖ {F}_{RF} {F}_{BB} ‖}_{F}^{2} = 1 ,\end{matrix} \qquad [ Equation 4 ]$$

Fₒₚₜ may denote an optimal beamforming matrix when there are no signal processing constraints, and F_{RF} may denote an analog beamforming matrix applied to antennas of the base station 11c. F_{BB} may denote a digital beamforming matrix applied to RF chains of the base station 11c, and a mathematical symbol ∥ ∥_{F} may be a Frobenius norm. The term “signal processing constraints” may refer to non-convex constraints, and the term “non-convex constraints” may refer to constraints that each component of the analog beamforming matrix should have the same absolute value, when considering characteristics of a phase shifter included in the base station 11c. For example, an absolute value of each component of the analog beamforming matrix may be 1.

The base station 11c may include first antennas 140c, and a first antenna 141c may be one of the first antennas 140c. The UE 12c may include second antennas 190c, and a second antenna 191c may be one of the second antennas 190c. In some embodiments, the base station 11c may adjust a spacing between the first antennas 140c by using the method 300 of adjusting a spacing between antennas described with reference to FIG. 3, and the UE 12c may adjust a spacing between the second antennas 190c by using the method 300 of adjusting a spacing between antennas described with reference to FIG. 3.

In an LoS environment, when the distance D between the first antennas 140c and the second antennas 190c is much greater than a dimension of an antenna arrangement in a device (e.g., when a distance D_{n,m} between the first antenna 141c and the second antenna 191c is approximated by the distance D between the first antennas 140c and the second antennas 190c), a matrix of a wireless channel between the base station 11c and the UE 12c may be approximated by using the following equation.

$$\begin{matrix}H \approx {D}_{r}^{*} {H}_{a} {D}_{t} \\ = {D}_{r}^{*} {U}_{a} {\sum }_{a} {V}_{a}^{*} {D}_{t} = U \sum {V}^{*}\end{matrix} \qquad [ Equation 5 ]$$

H may denote the matrix of the wireless channel between the base station 11c and the UE 12c, and Dᵣ* may denote a diagonal matrix including a phase term that is changed only by the second antennas 190c. Dₜ may denote a diagonal matrix including a phase term that is changed only by the first antennas 140c, and Hₐ may denote a matrix including a phase term that is affected by both the first antennas 140c and the second antennas 190c. Referring to Equation 5, it is found that singular value decomposition UΣV* of the matrix H of the wireless channel between the base station 11c and the UE 12c is related to singular value decomposition UₐΣₐVₐ* of the matrix including the phase term that is affected by both the first antennas 140c and the second antennas 190c.

In some embodiments, when Hₐ*Hₐ is defined as G(Nₜ) and HₐHₐ* is defined as G(Nᵣ), a right singular matrix of Hₐ may have the same property as an eigen matrix of G(Nₜ), and a left singular matrix of Hₐ may have th may have the same property as an eigen matrix of G(Nᵣ), which may be referred to as a first property. G(Nₜ) and G(Nᵣ) may each have a block-Toeplitz-block matrix structure, and a block-Toeplitz-block matrix may have a two-dimensional (2D) discrete Fourier transform matrix as an eigen matrix, which may be referred to as a second property. Using the first property, the second property, and Equation 5, singular value decomposition of the matrix H of the wireless channel between the base station 11c and the UE 12c may be expressed as in the following equation.

$$\begin{matrix}V = {{D}_{t}^{*} ( {Ω}_{{N}_{t , v}} ⊗ {Ω}_{{N}_{t , h}} )}^{*} \\ U = {{D}_{r}^{*} ( {Ω}_{{N}_{r , v}} ⊗ {Ω}_{{N}_{r , h}} )}^{*}\end{matrix} \qquad [ Equation 6 ]$$

Ω_{N}_{_{t,v}}, Ω_{N}_{_{t,h}}, Ω_{N}_{_{r,v}}, and Ω_{N}_{_{r,h}} may respectively denote a discrete Fourier transform matrix of dimension N_{t,v}, a discrete Fourier transform matrix of dimension N_{t,h}, and a discrete Fourier transform matrix of dimension N_{r,v}, and a discrete Fourier transform matrix of dimension N_{r,h}. Ω_{N}_{_{t,v}}⊗Ω_{N}_{_{t,h}} and Ω_{N}_{_{r,v}}⊗Ω_{N}_{_{r,h}} may each denote a value pre-determined by the property of the matrix Hₐ including the phase term that is affected by both the first antennas 140c and the second antennas 190c. Because each of the diagonal matrices Dᵣ* and Dₜ* has a phase term as a diagonal component, components of a right singular matrix V and a left singular matrix U of the matrix H of the wireless channel between the base station 11c and the UE 12c have the same absolute value, resulting in a unitary matrix. Accordingly, an optimization problem in Equation 4 may be solved by using the right singular matrix V and the left singular matrix U of the matrix H of the wireless channel between the base station 11c and the UE 12c.

In other words, because a beamforming matrix may be generated by using the right singular matrix V and the left singular matrix U of the matrix H of the wireless channel between the base station 11c and the UE 12c, the base station 11c and the UE 12c may generate a beamforming matrix by using the following equation.

$$\begin{matrix}{{F}_{RF} = {{D}_{t}^{*} ( {Ω}_{{N}_{t , v}} ⊗ {Ω}_{{N}_{t , h}} )}^{*} ]}_{1 : {N}_{s}} , {F}_{BB} = \frac{1}{{N}_{s}} {I}_{{N}_{s}} \\ {W}_{RF} = {[ {{D}_{r}^{*} ( {Ω}_{{N}_{r , v}} ⊗ {Ω}_{{N}_{r , h}} )}^{*} ]}_{1 : {N}_{s}} , {W}_{BB} = {I}_{{N}_{s} .}\end{matrix} \qquad [ Equation 7 ]$$

I_{N}_{ₛ} may denote an identity matrix of dimension Nₛ, and W_{RF} may denote an analog beamforming matrix applied to antennas of the UE 12c. W_{BB} may denote a digital beamforming matrix applied to RF chains of the UE 12c. A mathematical symbol [A]_{1:NS} may be a formula that allocates components of first to Nₛ^{th} columns from among components of a matrix A.

Because the base station 11c and the UE 12c may generate a beamforming matrix that solves an optimization problem by using Equation 7, complexity may be reduced and a beamforming gain may be increased, using a relatively small number of RF chains and assuming characteristics of an LoS environment.

FIG. 8 is a flowchart illustrating a beamforming matrix generation method of a wireless communication system, according to an embodiment. Referring to FIG. 8, a beamforming matrix generation method 800 of a wireless communication system may include a plurality of operations S810 to S830.

Referring further to FIG. 1, in operation S810, the base station 11 or the UE 12 may compare the number of data signals with a threshold number. The term “threshold number” may refer to the number of data signals in which a block-Toeplitz-block matrix has a 2D discrete Fourier transform matrix as an eigen matrix. For example, the base station 11 or the UE 12 may perform operation S820 when the number of data signals is greater than the threshold number, and may perform S830 when the number of data signals is equal to or less than the threshold number.

In operation S820, the base station 11 or the UE 12 may generate an analog beamforming matrix and a digital beamforming matrix by using characteristics of a block-Toeplitz-block matrix. Such characteristics may include a 2D discrete Fourier transform matrix as an eigen matrix. In some embodiments, the base station 11 or the UE 12 may generate an analog beamforming matrix and a digital beamforming matrix solving an optimization problem based on a singular matrix of a matrix of a wireless channel by using Equation 7 described with reference to FIG. 7.

In operation S830, the base station 11 or the UE 12 may generate an analog beamforming matrix and a digital beamforming matrix through use of a beamforming matrix generation algorithm. In some embodiments, the beamforming matrix generation algorithm may be as shown in the following table.

TABLE 1

| | |
|---|---|
| 1: | Inputs: |
| | V̅(Nₜ) = D*ₜ (Ω_{N}_{_{t,v}} ⊗ Ω_{N}_{_{t,h}})*, |
| | Fₒₚₜ = [V̅(Nₜ)]_{1:N}_{ₛ}_{,1:N}_{ₛ} |
| 2: | Initialize: |
| | F_{RF}⁰ = [ ], Fᵣₑₛ⁰ = Fₒₚₜ |
| 3: | for i = 1 to Nₛ do |
| 4: | k = maxₖ ([(V̅* (Nₜ)Fᵣₑₛⁱ⁻¹) (V̅ * (Nₜ)Fᵣₑₛⁱ⁻¹)^{*}]_{k,k}) |
| 5: | F_{RF}ⁱ = [F_{RF}ⁱ⁻¹ ∥ [V̅(Nₜ)]_{;,k}] |
| 6: | F_{BB}ⁱ = ((F_{RF}ⁱ) * F_{RF}ⁱ)⁻¹ (F_{RF}ⁱ)^{*} Fₒₚₜ |
| 7: | ${F}_{res}^{i} = \frac{{F}_{opt} - {F}_{RF}^{i} {F}_{BB}^{i}}{{‖ {F}_{opt} - {F}_{RF}^{i} {F}_{BB}^{i} ‖}_{F}^{2}}$ |
| 8: | end for |

The beamforming matrix generation algorithm may be an algorithm that generates an analog beamforming matrix and a digital beamforming matrix by taking content of a first row as an input, taking content of a second row as an initial value, and repeating content of first to seventh rows from an i^{th} column to an Nₛ^{th} column. Although Table 1 shows a beamforming matrix generation algorithm used by a transmitting end, a beamforming matrix generation algorithm used by a receiving end may be designed by making changes to suit variables of the receiving end.

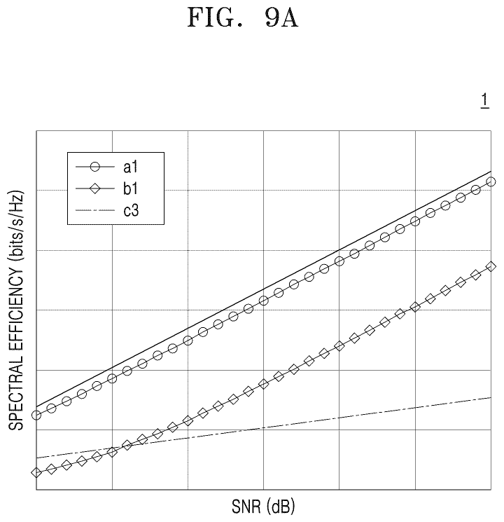

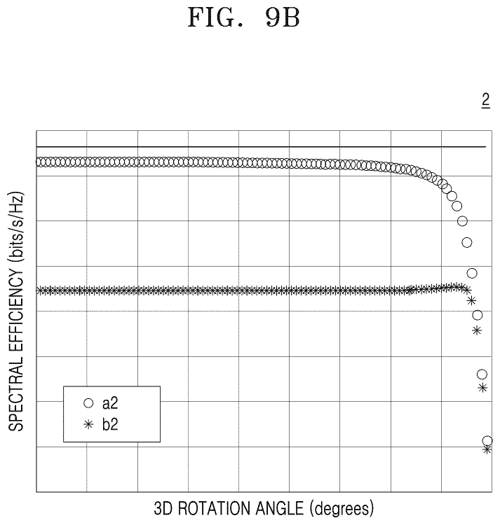

FIGS. 9A and 9B are graphs illustrating the effect of a method of adjusting a spacing between antennas of a device for performing wireless communication, according to an embodiment.

Referring to FIG. 9A, a first graph 1 is a graph illustrating spectral efficiency when a method a1 of adjusting a spacing between transmission/reception antennas arranged parallel to each other and having a balanced arrangement described with reference to FIGS. 2 to 6 is used, a method b1 according to a first comparative example is used, and a method cl according to a second comparative example is used. A horizontal axis of the first graph 1 represent signal-to-noise ratio (SNR) in dB, and a vertical axis represents spectral efficiency (bits/s/Hz). The method b1 according to the first comparative example is an antenna arrangement method in which different row vectors of a channel matrix are orthogonal to each other, and the method cl according to the second comparative example is a method in which a spacing between antennas is set to a half wavelength of a carrier frequency.

Referring to the first graph 1, it is found that the method a1 of adjusting a spacing between transmission/reception antennas parallel to each other and having a balanced arrangement described with reference to FIGS. 2 to 6 has spectral efficiency more than twice that of the method b1, and the method cl has very low spectral efficiency.

Referring to FIG. 9B, a second graph 2 is a graph showing spectral efficiency when a method a2 of adjusting a spacing between transmission/reception antennas not parallel to each other and having a balanced arrangement described with reference to FIG. 4 is used and a method b2 according to a third comparative example is used. A horizontal axis of the second graph 2 represents 3D rotation angle (degrees), and a vertical axis represents spectral efficiency (bits/s/Hz). The method b2 according to the third comparative example is an antenna arrangement method in which different row vectors of a matrix are orthogonal to each other after projection onto a plane perpendicular to a wireless channel.

Referring to the second graph 2, it is found that the method a2 according to an embodiment has higher spectral efficiency than the method b2.

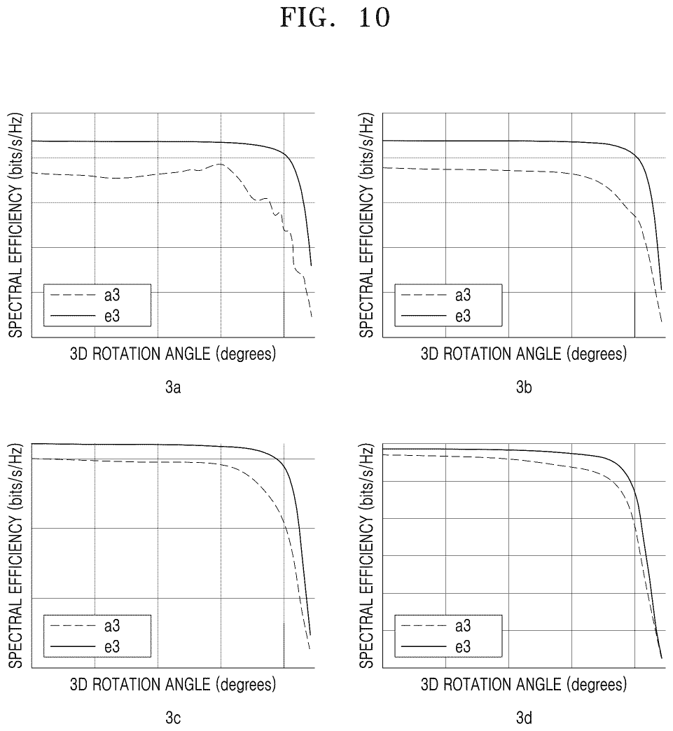

FIG. 10 is a graph illustrating the effect of a beamforming matrix generation method of a wireless communication system, according to an embodiment.

Referring to FIG. 10, third graphs 3a to 3d may be graphs showing spectral efficiency when a method a3 of generating a beamforming matrix by using a beamforming matrix generation algorithm described with reference to FIG. 8 is used and a theoretical method e3 is used in an ideal environment. Horizontal axes of the third graphs 3a to 3d represent 3D rotation angle, and vertical axes represent spectral efficiency (bits/s/Hz). The third graphs 3a to 3d are results with the same number of transmission antennas and different numbers of reception antennas and data signals, and the number of reception antennas and the number of data signals gradually increased from the third graph 3a to the third graph 3d.

Referring to the third graphs 3a to 3d, it is found that the method a3 according to an embodiment has high spectral efficiency close to that of the theoretical method e3 used in the ideal environment.

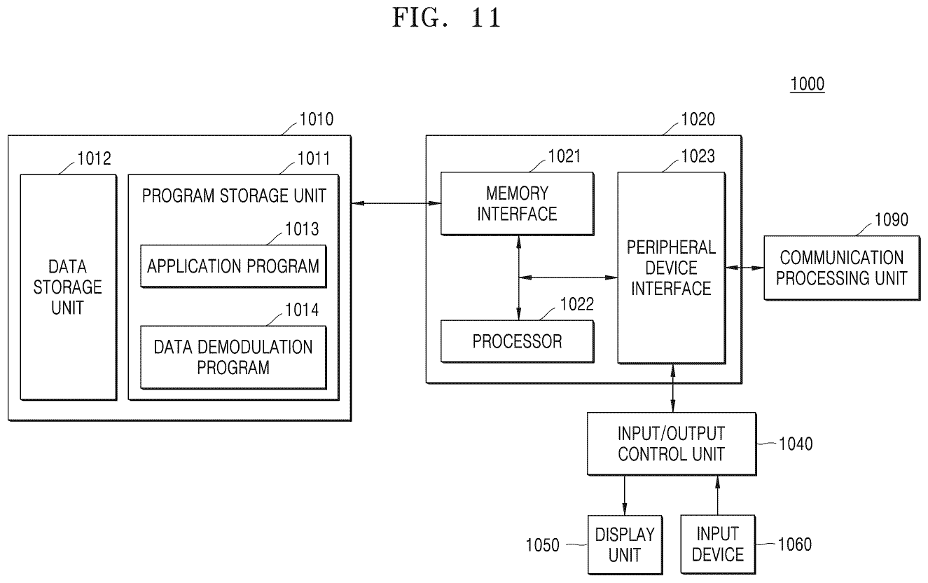

FIG. 11 is a block diagram illustrating an electronic device, according to an embodiment. An electronic device 1000 may be a UE according to an embodiment.

Referring to FIG. 11, the electronic device 1000 may include a memory 1010, a processor unit 1020, an input/output control unit 1040, a display unit 1050, an input device 1060, and a communication processing unit 1090. The electronic device 1000 may include a plurality of memories 1010. Each element is as follows.

The memory 1010 may include a program storage unit 1011 that stores a program for controlling an operation of the electronic device 1000 and a data storage unit 1012 that stores data generated during execution of the program. The data storage unit 1012 may store data required for an operation of an application program 1013 and a data demodulation program 1014, or may store data generated from an operation of the application program 1013 and the data demodulation program 1014. The program storage unit 1011 may include the application program 1013 and the data demodulation program 1014. The program included in the program storage unit 1011 may be expressed as an instruction set. The application program 1013 may include program code for executing various applications operating in the electronic device 1000. That is, the application program 1013 may include code (or commands) related to various applications driven by a processor 1022.

The electronic device 1000 may include the communication processing unit 1090 that performs a communication function for voice communication and data communication. A peripheral device interface 1023 may control connection between the input/output control unit 1040, the communication processing unit 1090, the processor 1022, and a memory interface 1021. The processor 1022 may communicate with a plurality of base stations that provide corresponding services, by using at least one software program. In this case, the processor 1022 may execute at least one program stored in the memory 1010 and may provide a service corresponding to the at least one program.

The processor 1022 may adjust a spacing between transmission/reception antennas based on data signals as described with reference to FIGS. 1 to 8 and may generate a beamforming matrix based on a singular matrix of a matrix of a wireless channel to increase a data rate.

The input/output control unit 1040 may provide an interface between an input/output device, such as the display unit 1050 and the input device 1060, and the peripheral device interface 1023. The display unit 1050 displays state information, input characters, moving pictures, still pictures, etc. For example, the display unit 1050 may display application program information driven by the processor 1022.

The input device 1060 may provide input data generated by selection of the electronic device 1000 to the processor unit 1020 through the input/output control unit 1040. In this case, the input device 1060 may include a keypad including at least one hardware button and a touch pad for sensing touch information. For example, the input device 1060 may provide touch information, such as a touch, a touch movement, and a touch release, sensed through the touch pad, to the processor 1022 through the input/output control unit 1040.

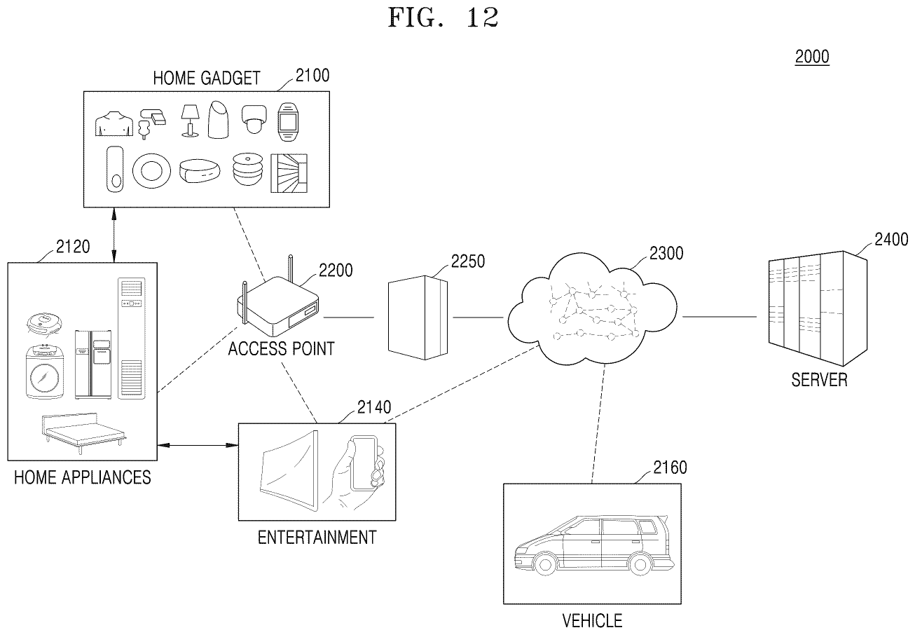

FIG. 12 is a conceptual diagram illustrating an Internet of things (IoT) network system to which an embodiment is applied.

Referring to FIG. 12, an IoT network system 2000 may include a plurality of IoT devices 2100, 2120, 2140, and 2160, an AP 2200, a gateway 2250, a wireless network 2300, and a server 2400. The IoT may refer to a network between objects using wired/wireless communication.

Each of the IoT devices 2100, 2120, 2140, and 2160 may form a group according to characteristics of each IoT device. For example, the IoT devices may be grouped into a home gadget group 2100, a home appliance/furniture group 2120, an entertainment group 2140, or a vehicle group 2160. The plurality of IoT devices 2100, 2120, and 2140 may be connected to a communication network or may be connected to other IoT devices through the AP 2200. The AP 2200 may be provided in one IoT device. The gateway 2250 may change a protocol to connect the AP 2200 to an external wireless network. The IoT devices 2100, 2120, and 2140 may be connected to an external communication network through the gateway 2250. The wireless network 2300 may include the Internet and/or a public network. The plurality of IoT devices 2100, 2120, 2140, and 2160 may be connected to the server 2400 that provides a certain service through the wireless network 2300, and a user may use a service through at least one of the plurality of IoT devices 2100, 2120, 2140, and 2160.

The plurality of IoT devices 2100, 2120, 2140, and 2160 may adjust a spacing between transmission/reception antennas based on data signals as described with reference to FIGS. 1 to 8 and may generate a beamforming matrix based on a singular matrix of a matrix of a wireless channel to increase a data rate.

Embodiments have been described with reference to the drawings and the specification. While embodiments have been described by using specific terms, the terms have merely been used to explain the technical idea of the inventive concept and should not be construed as limiting the scope of the inventive concept defined by the claims. Hence, it will be understood by one of ordinary skill in the art that various modifications and other equivalent embodiments may be made therefrom. Accordingly, the technical scope of the inventive concept should be defined by the following claims.

While the inventive concept has been particularly shown and described with reference to embodiments thereof, it will be understood that various changes in form and details may be made therein without departing from the spirit and scope of the following claims.

What is claimed is:

1. A second device comprising:
second antennas configured to transmit and receive radio frequency (RF) signals to and from a first device comprising first antennas in a wireless communication system;
at least one RF chain configured to transmit and receive the RF signals to and from the second antennas; and
a processing circuit configured to transmit and receive data signals to and from the at least one RF chain,
wherein the processing circuit is further configured to adjust a spacing between the second antennas based on a number of the first antennas, a number of the second antennas, and a number of the data signals.

2. The second device of claim 1, wherein the spacing between the second antennas is an equal interval.

3. The second device of claim 1, wherein an arrangement of the second antennas is one of a planar array or a linear array.

4. The second device of claim 3, wherein the second antennas are arranged parallel to the first antennas,
wherein the processing circuit is further configured to:
adjust a spacing between the second antennas in a first direction based on a number of first antennas arranged in the first direction from among the first antennas, a number of second antennas arranged in the first direction from among the second antennas, and a number of data signals to be transmitted/received by antennas arranged in the first direction from among the data signals, and
adjust a spacing between the second antennas in a second direction based on a number of first antennas arranged in the second direction from among the first antennas, a number of second antennas arranged in the second direction from among the second antennas, and a number of data signals to be transmitted/received by antennas arranged in the second direction from among the data signals,
wherein the first direction is perpendicular to the second direction and parallel to the second antennas, and
the second direction is parallel to the second antennas.

5. The second device of claim 3, wherein the processing circuit is further configured to:
adjust a spacing between the second antennas in a first direction based on a number of first antennas arranged in the first direction from among the first antennas, a number of second antennas arranged in the first direction from among the second antennas, and a number of data signals to be transmitted/received by antennas arranged in the first direction from among the data signals,
adjust a spacing between the second antennas in a second direction based on a number of first antennas arranged in the second direction from among the first antennas, a number of second antennas arranged in the second direction from among the second antennas, and a number of data signals to be transmitted/received by antennas arranged in the second direction from among the second antennas, and
adjust a spacing between the second antennas in a third direction based on the spacing between the second antennas in the first direction, the spacing between the second antennas in the second direction, an angle from an axis in the first direction, and an angle from an axis in the second direction,
wherein the first direction is perpendicular to the second direction and the third direction, and
the second direction is perpendicular to the third direction.

6. The second device of claim 1, wherein the processing circuit is further configured to adjust a spacing between the second antennas so that a rank of a channel matrix formed between the first device and the second device is same as the number of the data signals.

7. The second device of claim 1, wherein the processing circuit is further configured to generate a digital beamforming matrix to be applied to the at least one RF chain and an analog beamforming matrix to be applied to the second antennas,
wherein the analog beamforming matrix is a matrix in which each component of the analog beamforming matrix has a same absolute value.

8. The second device of claim 7, wherein the processing circuit is further configured to calculate a left singular matrix and a right singular matrix by using singular value decomposition (SVD) of a channel matrix formed between the first device and the second device and generate the analog beamforming matrix based on at least one of the left singular matrix or the right singular matrix.

9. The second device of claim 8, wherein the processing circuit is further configured to generate the analog beamforming matrix by applying components of a first column to a column corresponding to the number of the data signals from among columns of at least one of the left singular matrix or the right singular matrix.

10. The second device of claim 1, wherein a number of the at least one RF chain is less than the number of the second antennas.

11. An operating method of a second device comprising second antennas and at least one radio frequency (RF) chain and configured to perform wireless communication with a first device comprising first antennas, the operating method comprising:
reporting information about a number of the at least one RF chain to the first device;
receiving antenna adjustment information generated based on the information about the number of the at least one RF chain; and
adjusting a spacing between the second antennas based on the antenna adjustment information,
wherein the antenna adjustment information comprises a number of the first antennas, a number of the second antennas, a distance between the first device and the second device, and a number of data signals received by the second device.

12. The operating method of claim 11, wherein an arrangement of the second antennas is one of a planar array or a linear array,
wherein the adjusting of the spacing between the second antennas comprises adjusting the spacing between the second antennas to be an equal spacing based on the antenna adjustment information.

13. The operating method of claim 11, further comprising generating a digital beamforming matrix to be applied to the RF chain and an analog beamforming matrix to be applied to the second antennas,
wherein the analog beamforming matrix is a matrix in which each component of the analog beamforming matrix has a same absolute value.

14. The operating method of claim 13, wherein the generating of the digital beamforming matrix to be applied to the RF chain and the analog beamforming matrix to be applied to the second antennas comprises:
calculating a left singular matrix and a right singular matrix by using singular value decomposition (SVD) of a channel matrix formed between the first value and the second value; and
generating the analog beamforming matrix based on at least one of the left singular matrix or the right singular matrix.

15. The operating method of claim 11, wherein the number of the RF chain is less than the number of the second antennas.

16. A wireless communication system comprising:
a first device comprising first antennas, at least one first radio frequency (RF) chain configured to transmit and receive RF signals to and from the first antennas, and a first processing circuit configured to transmit and receive data signals to and from the at least one first RF chain; and
a second device comprising second antennas configured to transmit and receive the RF signals to and from the first antennas, at least one second RF chain configured to transmit and receive the RF signals to and from the second antennas, and a second processing circuit configured to transmit and receive the data signals to and from the at least one second RF chain,
wherein the first processing circuit is further configured to adjust a spacing between the first antennas based on a number of the first antennas, a number of the second antennas, a distance between the first device and the second device, a wavelength of a carrier frequency, and a number of the data signals, and
the second processing circuit is further configured to adjust a spacing between the second antennas based on the number of the first antennas, the number of the second antennas, the distance between the first device and the second device, the wavelength of the carrier frequency, and the number of the data signals.

17. The wireless communication system of claim 16, wherein the spacing between the first antennas and the spacing between the second antennas are equal.

18. The wireless communication system of claim 16, wherein the first processing circuit is further configured to adjust the spacing between the first antennas so that a rank of a channel matrix formed between the first device and the second device is same as the number of the data signals, and
the second processing circuit is further configured to adjust the spacing between the second antennas so that the rank of the channel matrix formed between the first device and the second device is same as the number of the data signals.

19. The wireless communication system of claim 16, wherein the first processing circuit is further configured to generate a first digital beamforming matrix to be applied to the at least one first RF chain and a first analog beamforming matrix to be applied to the first antennas, and
the second processing circuit is further configured to generate a second digital beamforming matrix to be applied to the at least one second RF chain and a second analog beamforming matrix to be applied to the first antennas,
wherein the first analog beamforming matrix is a matrix in which each component of the first analog beamforming matrix has a same absolute value, and
the second analog beamforming matrix is a matrix in which each component of the second analog beamforming matrix has a same absolute value.

20. The wireless communication system of claim 19, wherein the first processing circuit is further configured to calculate a right singular matrix by using singular value decomposition (SVD) of a channel matrix formed between the first device and the second device and generate the first analog beamforming matrix based on the right singular matrix, and
the second processing circuit is further configured to calculate a left singular matrix by using SVD of the channel matrix formed between the first device and the second device and generate the second analog beamforming matrix based on the left singular matrix.
